(19) United States
(12) Patent Application Publication
(10) Pub. No.: US 2023/0243713 A1
(43) Pub. Date: Aug. 3, 2023

(54) System and Method for Determining Railcar Attributes

(71) Applicant: FreightLucid, LLC, Dallas, TX (US)

(72) Inventor: Kenneth W. Huck, Fairview, TX (US)

(21) Appl. No.: 18/151,751

(22) Filed: Jan. 9, 2023

Related U.S. Application Data
(60) Provisional application No. 63/305,350, filed on Feb. 1, 2022.

(51) Int. Cl. G01M 1/12; G01G 19/04

(52) U.S. Cl. CPC G01M 1/122; G01G 19/042

(57) ABSTRACT

A system for determining a center of gravity (COG) of a commodity of a railcar comprises a plurality of sensors and a computing device. At least a first sensor from the plurality of sensors is disposed on a first center plate of the railcar. At least a second sensor from the plurality of sensors is disposed on a second center plate of the railcar. Each sensor is configured to determine a change in force imposed on the sensor based on a change in micro strain on the sensor. The computing device receives a plurality of force values from the plurality of sensors. The computing device determines a weight of the railcar body and commodity by combining the received force values. The computing device determines the COG of the railcar body and commodity based at least on the plurality of force values and the weight of the railcar.

### RELATED APPLICATION AND CLAIM TO PRIORITY

This application claims priority to U.S. Provisional Application No. 63/305,350 filed Feb. 1, 2022 and titled “SYSTEM AND METHOD FOR DETERMINING RAILCAR ATTRIBUTES,” which is incorporated herein by reference.

### TECHNICAL FIELD

This disclosure relates generally to railcars and, more particularly, to a system and method for determining railcar attributes.

### BACKGROUND

Railcars are used for transporting commodities. Railcars have weight restrictions to protect the railroad infrastructure and provide for efficient operation of the railcars. Overloading railcars can damage rail systems, promote accelerated wear and reduce the life of railcars. Weighing railcars before, during, and after transporting commodities is common in the transportation industry.

In addition, railcars have center of gravity restrictions to prevent the railcars from tipping over to aside. Railcars have a maximum height for the combined center of gravity of the railcar body and commodity in which they must operate. It is challenging to calculate the center of gravity of the commodity carried by a railcar. For example, if the commodity is distributed unevenly in the railcar, the railcar may tip over to a side of the rail. In another example, if the combined center of gravity of the railcar body and commodity is too close to one end of the railcar or the other, the truck may be overloaded. The AAR also has restrictions on the distribution of weight between the railcar trucks regardless if the weight of the railcar is at the maximum allowed or at some lesser value.

### SUMMARY

To address the foregoing problems, various embodiments are disclosed herein for determining railcar attributes, and in particular a center of gravity (COG) of a commodity carried by a railcar. The COG of the combined railcar body and commodity of the railcar may correspond to the center of the mass of the empty railcar body plus the commodity. In certain embodiments, the COG of the commodity may be determined using the weight of the railcar body. The weight of the empty railcar body or loaded railcar body may be determined using one or more sensors disposed on the center plates of a railcar. The center plates are among the components that support the structure of the railcar. The railcar sits on truck assemblies that include the center plates.

Each sensor is configured to determine a change in force imposed on the sensor based on a change in microstrain of the sensor. The weight of the railcar body may be determined by combining the force values measured by the sensors. The weight of the railcar body may be used in determining the COG of the combined railcar body and commodity loaded in the railcar. In addition, the location of each sensor on its respective center plate is known and may be used in determining the COG of the combined railcar body and the commodity.

The COG of the combined railcar body and the commodity may be determined using a longitudinal COG (COG_{L}), a vertical COG (COG_{V}), and a transverse COG (COG_{T}). The COG may correspond to a point in 3D space where the location of the COG is represented by the COG_{L}, COG_{V}, and COG_{T}. The COG_{L} is a center of mass of the combined railcar body and the commodity with respect to the longitudinal axis (or length) of the railcar. The COG_{V} is the height of the center of mass of the combined railcar body and the commodity above the center plate of the railcar. In one embodiment, the COG_{V} may be added to the height of the center plate to determine the height of the COG_{V} from the rail track. The COG_{T} is a distance between the center of the transversal axis (or width) of the railcar and the COG.

Certain embodiments may provide one or more technical advantages. For example, determining the COG of the combined railcar body and the commodity may prevent the railcar from tipping over to a side of the rail track. For example, upon determining that the COG is offset in position from the center of the width more than a threshold value, the commodity may be redistributed to prevent the railcar from tipping over.

The COG may either be determined when the railcar is stationary or in motion, e.g., while in transit. Thus, in cases where it is determined that the COG is offset in position from the center of the width more than a threshold value, appropriate actions may be performed. For example, if the railcar is in motion, the railcar may be stopped and the commodity may be redistributed to prevent the railcar from tipping over. In another example, if the railcar is stationary, the commodity may be redistributed before the railcar starts traveling. Several embodiments are elaborated on in this disclosure. In accordance with a particular embodiment, a system for determining railcar attributes comprises a plurality of sensors and a computing device.

The plurality of sensors comprises a first set of one or more sensors disposed on a first center plate of a railcar. The plurality of sensors further comprises a second set of one or more sensors disposed on a second center plate of the railcar. Each sensor from the plurality of sensors is configured to determine a change in force imposed on the sensor based on a change in microstrain on the sensor.

The computing device is communicatively coupled with the plurality of sensors. The computing device comprises a processor. The processor is configured to receive a first set of one or more force values from the first set of one or more sensors. The processor receives a second set of one or more force values from the second set of one or more sensors. The processor determines a weight of a railcar body and a commodity loaded in the railcar by combining the first set of one or more force values and the second set of one or more force values. The processor determines the COG of the combined railcar body and the commodity based at least on the first set of one or more force values, the second set of one or more force values, and the weight of the combined railcar body and the commodity.

Certain embodiments of the present disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1A illustrates a side view of an embodiment of a railcar with a center of gravity of a combined railcar body and commodity of the railcar;

FIG. 1B illustrates a top view of an embodiment of the railcar of FIG. 1A with truck assemblies;

FIG. 2 illustrates a front view of the railcar of FIG. 1A;

FIG. 3A illustrates a top view of an embodiment of truck's center plates with sensors;

FIG. 3B illustrates a perspective view of an embodiment of truck's center plates with sensor measurements;

FIG. 4 illustrates a side view of an embodiment of a railcar with a net force applied to the combined railcar body and commodity center of gravity;

FIG. 5 illustrates an example plot of the vertical center of gravity measurements;

FIG. 6 illustrates an embodiment of a system for determining the center of gravity of a combined railcar body and commodity of a railcar and its weight applied to each truck; and

FIG. 7 illustrates an example flowchart for determining the center of gravity of a combined railcar body and commodity of a railcar.

### DETAILED DESCRIPTION

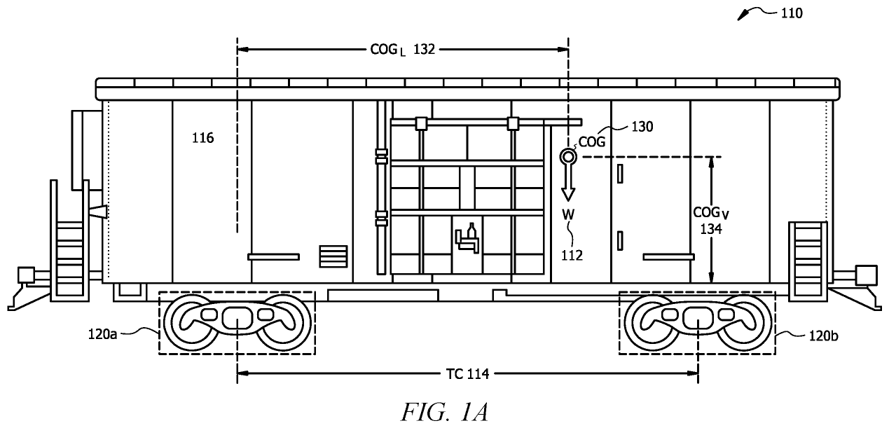

FIG. 1A illustrates a side view of an embodiment of a railcar 110. Examples of the railcar 110 may include a railroad car, a hopper car, and a tank car. The railcar 110 is configured to transport commodities, e.g., coal, sand, metal ores, ballast, aggregates, grain, and any other type of lading. A railcar 110 is the combination of the railcar body 116 and two truck assemblies 120a and 120b. The weight of the combined railcar body 116 and commodity is noted as weight (W) 112.

FIG. 1A further illustrates an example location of a center of gravity (COG) 130 of a combined railcar body 116 and commodity carried by the railcar 110. Railcars 110 have center of gravity restrictions by which they must operate to prevent the railcars 110 from tipping over to aside. For example, railcars 110 have a maximum height for the center of gravity of the commodity in which they must operate. There are restrictions on the maximum weights that trucks 120a and 120b can support. There are also restrictions on the percentage of railcar weight distribution between trucks 120a and 120b whether the railcar 110 is at maximum capacity or at some lesser value.

Depending on the distribution of the commodity in the railcar 110, the COG 130 of the combined railcar body 116 and commodity may be at different locations. For example, in cases where the commodity is evenly distributed longitudinally in the railcar 110 (i.e., with respect to the longitudinal axis or length of the railcar 110), the COG 130 may be in the middle of the railcar 110 along the longitudinal axis of the railcar 110. In another example, in cases where the commodity is evenly distributed transversely in the railcar 110 (i.e., with respect to the width of the railcar 110), the COG 130 may be in the middle of the railcar 110 along the transversal axis (or the width) of the railcar 110.

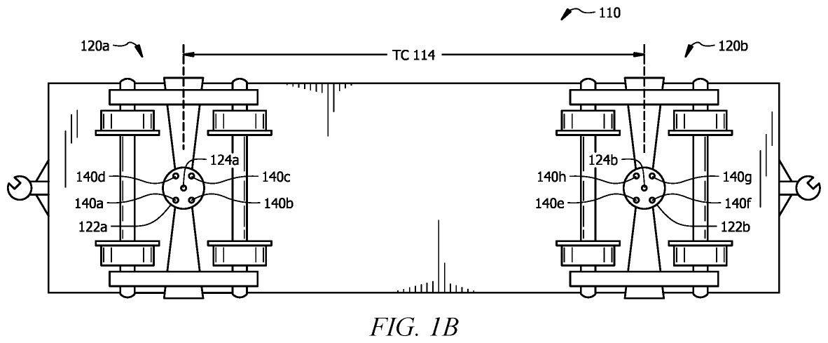

In the example of FIG. 1A, the commodity of the railcar 110 is not distributed evenly with respect to the longitudinal axis of the railcar 110. Thus, the COG 130 is shown offset in position from the middle of the longitudinal axis (or length) of the railcar 110. Referring to FIG. 2, the commodity of the railcar 110 is not distributed evenly with respect to the transversal axis (or width) of the railcar 110. Thus, the COG 130 is shown offset in position from the middle of the transversal axis (or the width) of the railcar 110.

Referring back to FIG. 1A, in some cases, if the commodity is not distributed evenly (or the COG 130 is offset from the center of the longitudinal axis of the railcar 110 more than a threshold distance), it may lead to the railcar 110 tipping over to a side of a rail track or overloading one of the trucks. For example, in some cases, the commodity may be too wide to be laid down flat in the railcar 110, such as when the commodity is stick-steel plates or metal slabs. In such cases, the commodity may be leaned against one side of the railcar 110. This may cause the COG 130 of the combined railcar body 116 and commodity to be offset from the centerline of the railcar 110. In some cases, the railcar 110 may travel over a curved rail track. Thus, if the commodity is not distributed evenly (or the COG 130 is offset from the center of the longitudinal axis of the railcar 110 more than a threshold distance), it may lead to the railcar 110 tipping over to a side of a rail track when the railcar 110 goes around the curved rail track.

The present disclosure contemplates determining the location of the COG 130, for example, so that if the COG 130 is offset from the center of the railcar 110 (longitudinally and/or transversally) more than a threshold distance and/or if the height of the COG 130 is more than a threshold height indicated by restrictions (e.g., more than 98 inches above the rail), the commodity can be redistributed to prevent the railcar 110 from tipping over a side of a rail track.

In one embodiment, to determine the location of the COG 130 in the railcar 110, longitudinal COG (COG_{L}) 132, vertical COG (COG_{V}) 134, and transverse COG (COG_{T}) 136 (see FIG. 2) are determined. The COG 130 may correspond to a point in 3D space where the location of the COG 130 is represented by the COG_{L} 132, COG_{V} 134, and COG_{T} 136 (see FIG. 2).

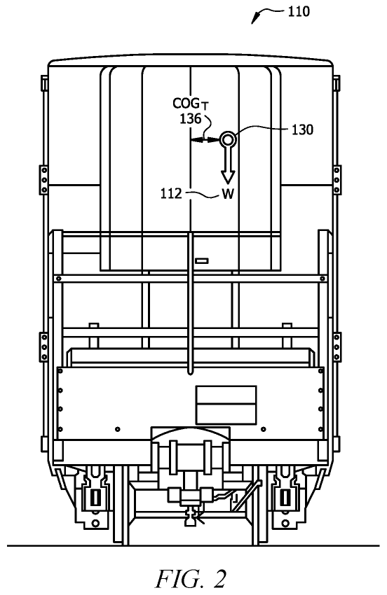

Each of the COG_{L} 132, COG_{V} 134, and COG_{T} 136 is described in greater detail further below. In brief, the COG_{L} 132 is a center of mass of the combined railcar body 116 and commodity with respect to the longitudinal axis (or length) of the railcar 110. The COG_{L} 132 may correspond to a distance between the location of the COG 130 and a center plate pin 124 (see FIG. 1B) of a center plate 122 (see FIG. 1B). The COG_{V} 134 is the height of the center of mass of the combined railcar body 116 and commodity above the center plate 122 (see FIG. 1B) of the railcar 110. In other words, the COG_{V} 134 is a height of the COG 130 above the center plate 122 (see FIG. 1B). In one embodiment, the COG_{V} 134 may be added with the height of the center plate 122 (see FIG. 1B) to determine the COG_{V} 134 above the rail track. The COG_{T} 136 (see FIG. 2) is a distance between the center of the transversal axis (or width) of the railcar 110 to the COG 130. The COG_{L} 132, COG_{V} 134, and COG_{T} 136 may be determined based on measurements of sensors 140 (see FIG. 1B). The calculations of the COG_{L} 132, COG_{V} 134, and COG_{T} 136 are described further below in FIGS. 3A and 3B.

The COG 130, COG_{L} 132, COG_{V} 134, and COG_{T} 136 are determined using sensor measurements of sensors 140 disposed on truck assemblies 120. The truck assemblies 120 are parts of an underframe of the railcar 110. The railcar body 116 is supported by an underframe. The railcar body 116 sits on top of the underframe. The underframe may include railcar wheels, wheel bearings, wheel axels, truck assemblies 120, among other components. The underframe supports a holding structure of the railcar body 116. The holding structure may be a tank, open wagon, closed wagon, hopper, etc. The truck assembly 120 is described in FIG. 1B.

FIG. 1B illustrates a top view of the embodiment of the railcar 110 of FIG. 1A with truck assemblies 120a and 120b. Each truck assembly 120 includes a center plate 122 and a center plate pin 124. The truck assembly 120a includes a center plate 122a and a center plate pin 124a. The truck assembly 120b includes a center plate 122b and a center plate pin 124b. Each of the center plates 122a and 122b is an instance of the center plate 122.

The center plate 122 is made from a high-strength material (for example, steel) and supports the weight of the railcar body 116 on sensor 140. While center plate 122 is depicted as circular, it is understood that center plate 122 can be in any shape and may be of any size that supports the sensor 140.

The center plate pin 124 may be coupled to the railcar body 116. The center plate 122 may have a center opening where the center plate pin 124 can extend through. The center plate 122 and the center pin support the railcar structure. The distance between the center plate pin 124a and the center plate pin 124b is TC 114, where TC stands for truck center distance.

One or more sensors 140 may be disposed on each center plate 122. For example, a first set of one or more sensors 140a to 140d may be disposed on the center plate 122a, and a second set of one or more sensors 140e to 140h may be disposed on the center plate 122b. Each of the sensors 140a to 140h may be an instance of a sensor 140. The sensor 140 may be configured to determine a change in force imposed on the sensor 140 based on a change in microstrain of the sensor 140. For example, each sensor 140 may be configured to generate an electrical signal (e.g., voltage (V), current (I)) in response to a force or a pressure imposed on the sensor 140. The force applied to the sensor 140 is a function of the weight detected by the sensor 140. Examples of the sensor 140 may include a bulk metallic glass (BMG) sensor, a weight sensor, a pressure sensor, and the like. The BMG sensor may include a BMG plug coupled to a microstrain sensor. The BMG plug may be disposed on a center plate 122. The microstrain sensor may be operable to determine a change in macro strain on the BMG sensor. Additional details of the sensor 140 are disclosed in U.S. Patent Publication No. 2021/0053595 A1 entitled, “BULK METALLIC GLASS LOAD CELL” which is hereby incorporated by reference herein as if reproduced in its entirety.

The sensors 140 are used in weighing the railcar 110. In one embodiment, the weight 112 of the railcar body 116 and commodity may be determined by combining the force values (F) detected by the sensors 140. Furthermore, based on the force values (F) detected by the sensors 140, the positions of the sensors 140 on the center plate 122, and the weight 112 of the railcar body 116 and commodity, the COG 130 of the railcar body 116 and commodity may be determined, as described further below in FIGS. 3A and 3B.

By weighing an empty railcar 110 in a similar fashion, the commodity weight and its COG may be determined by comparing the weight of the empty railcar to the weight of the loaded railcar. In this process, the commodity weight and its COG may be determined by subtracting the weight and COG of the empty railcar body 116 from the weight of the loaded railcar body 116 and commodity, respectively. The weight of the commodity may be determined by subtracting a weight of an empty railcar body 116 from the weight of the railcar body 116 loaded with the commodity. The COG of the commodity may be determined by subtracting a COG of an empty railcar body 116 from a COG of the railcar body 116 loaded with the commodity.

FIG. 2 illustrates a front view of an embodiment of the railcar 110. In the example of FIG. 2, the COG_{T} 136 is shown where the COG 130 is offset in position from the centerline along the transversal axis (or the width) of the railcar 110.

FIG. 3A illustrates a top view of the truck's center plates 122a and 122b of a railcar 110 of FIG. 1A with sensors 140. In FIG. 3A, the truck assemblies 120a and 120b include the first center plate 122a and the second center plate 122b, respectively. The center plate pin 124a is disposed at the center of the first center plate 122a. The center plate pin 124b is disposed at the center of the center plate 122b. The distance between the center plate pin 124a and the center plate pin 124b is TC 114.

In the illustrated embodiment, a first set of one or more sensors 140a to 140d is disposed on the center plate 122a, and a second set of one or more sensors 140e to 140h is disposed on the center plate 122b. In other embodiments, the number of sensors 140 used in each center plate 122 may vary. As such, the COG_{L} 132, COG_{V} 134, and COG_{T} 136 may be determined using various numbers of sensors 140. However, using more sensors 140 may increase the accuracy of the calculations of the COG_{L} 132, COG_{V} 134, and COG_{T} 136. In the illustrated embodiment, four sensors 140 are disposed on each center plate 122 and used for the calculations of COG_{L} 132, COG_{V} 134, and COG_{T} 136. In other embodiments, fewer or more sensors 140 may be used.

For calculating a more accurate COG_{L} 132, it is important to have one or more sensors 140 on either side of each center plate pin 124a and 124b longitudinally, i.e., along the length of the railcar 110. For a more accurate calculation of COG_{T} 136, it is important to have one or more sensors 140 on either side of each center plate pin 124a and 124b transversely, i.e., along the width of the railcar 110.

Depending on a method used to calculate the COG_{V} 134, for more accurate calculations of the COG_{L} 132, COG_{V} 134, and COG_{T} 136, it is important to have one or more sensors 140 on either side of each center plate pin 124a and 124b transversely (i.e., along the width of the railcar 110) and/or longitudinally (i.e., along the length of the railcar 110). In all cases, the further apart are the sensors 140 on a given center plate 122, the more accurate the result of the calculations of the COG_{L} 132, COG_{V} 134, and COG_{T} 136 may be.

The corresponding description below describes the locations of the sensors 140a-140d with respect to the center plate 122a. The distance between the sensor 140a and the vertical centerline 302 is “a”. The vertical centerline 302 corresponds to a line at the center of the center plate 122a along the width or transversal axis of the railcar 110. The distance between the sensor 140a and the horizontal centerline 304 is “c”. The horizontal centerline 304 corresponds to the longitudinal centerline along the length or longitudinal axis of the railcar 110. The distance between the sensor 140b and the vertical centerline 302 is “b”. The distance between the sensor 140b and the horizontal centerline 304 is “c”. The distance between the sensor 140c and the vertical centerline 302 is “b”. The distance between the sensor 140c and the horizontal centerline 304 is “d”. The distance between the sensor 140d and the horizontal centerline 304 is “d”. The distance between the sensor 140d and the vertical centerline 302 is “a”.

The sensors 140a and 140d are disposed adjacent to a first end of the railcar 110. The sensors 140b and 140c are disposed adjacent to the middle of the railcar 110. The sensors 140a and 140b are disposed on one side (e.g., left or right side) of the center plate pin 124a, and the sensors 140c and 140d are disposed on another side of the center plate pin 124a.

The corresponding description below describes the locations of the sensors 140e-140h with respect to the center plate 122b. The distance between the sensor 140e and the vertical centerline 306 is “e”. The vertical centerline 306 corresponds to a line at the center of the center plate 122b along the width or transversal axis of the railcar 110. The distance between the sensor 140e and the horizontal centerline 304 is “g”. The distance between the sensor 140f and the vertical centerline 306 is “f”. The distance between the sensor 140f and the horizontal centerline 304 is “g”. The distance between the sensor 140g and the vertical center 306 is “f”. The distance between the sensor 140g and the horizontal centerline 304 is “h”. The distance between the sensor 140h and the horizontal centerline 304 is “h”. The distance between the sensor 140h and the vertical centerline 306 is “e”.

The sensors 140f and 140g are disposed adjacent to a second end of the railcar 110. The sensors 140e and 140h are disposed adjacent to the middle of the railcar 110. The sensors 140e and 140f are disposed on one side (e.g., left or right side) of the center plate pin 124b, and the sensors 140g and 140h are disposed on another side of the center plate pin 124b.

FIG. 3B illustrates a perspective view of an embodiment of truck's center plates 122 with sensor measurements, for example, force values 310a to 310h detected by the sensors 140a to 140h, respectively. As described in FIG. 1B, each sensor 140 is configured to detect a force value (F) 310 based on a change in microstrain on the sensor 140.

In the example of FIG. 3B, a force value 310a detected by sensor 140a is noted as F1, a force value 310b detected by sensor 140b is noted as F2, a force value 310c detected by sensor 140c is noted as F3, a force value 310d detected by sensor 140d is noted as F4, a force value 310e detected by sensor 140e is noted as F5, a force value 310f detected by sensor 140f is noted as F6, a force value 310g detected by sensor 140g is noted as F7, and force value 310h detected by sensor 140h is noted as F8.

In certain embodiments, the weight 112 of the railcar body 116 loaded with a commodity may be determined according to an equation (1) as below:

Weight (W)=F1+F2+F3+F4+F5+F6+F7+F8 Eq. (1)

The F1 to F8 correspond to force values 310a to 130h, respectively. In equation (1), eight force values 310a to 130h are added to determine the weight 112 of the railcar body 116 and commodity. In embodiments where another number of sensors 140 is used, the equation (1) may be adjusted to include the force values 310 detected by the sensors 140.

Railcar body 116 and commodity weight applied to each truck assembly 120a and 120b at the center plate may also be calculated according to the equation (2) below:

W₁₂₀ₐ=F1+F2+F3+F4 W_{120b}=F5+F6+F7+F8 Eq. (2)

where W₁₂₀ₐ is a first weight of the railcar body 116 and commodity applied to (and experienced by) the first truck assembly 120a at the center plate 122a; and W_{120b} is a second weight of the railcar body 116 and commodity applied to (and experienced by) the second truck assembly 120b at the center plate 122b. The accumulation of W₁₂₀ₐ and W_{120b} will result in the total weight 112 of the railcar body 116 and commodity.

Using the weight of the railcar body 116 and commodity the positions of the sensors 140a to 140d on the center plate 122a, the positions of the sensors 140e to 140h on the center plate 122b, and the TC 114, the COG_{L} 132 may be calculated. In certain embodiments, the COG_{L} 132 may be determined according to an equation (3) as below:

$${COG}_{L} = [ \begin{matrix}- ( F 1 + F 4 ) \times a + ( F 2 + F 3 ) \times b + ( F 5 + F 8 ) \times \\ ( TC - e ) + ( F 6 + F 7 ) \times ( TC + f )\end{matrix} ] / W \qquad Eq . ( 3 )$$

The variables F1-F8, a, b, e, f, TC, are described above. W corresponds to the weight of the railcar body 116 and commodity. In equation (3), eight sensors 140a to 140h are used. In embodiments where another number of sensors 140 is used, the equation (3) may be adjusted according to the detected force values 310 and positions of the sensors 140 with respect to their respective center plates 122.

Using the weight of the railcar body 116 and commodity, the positions of the sensors 140a to 140d on the center plate 122a, the positions of the sensors 140e to 140h on the center plate 122b, and the distance between the center plate pins 124a and 124b, the COG_{T} 136 may be calculated. In certain embodiments, the COG_{T} 136 may be determined according to an equation (4) as below:

COG_{T}=[−(F1+F2)×c+(F3+F4)×d−(F5+F6)×g+(F7+F8)×h]/W Eq. (4)

The variables F1-F8, c, d, g, h, and W are described above. In the equation (4), eight sensors 140a to 140h are used. In embodiments where another number of sensors 140 is used, the equation (4) may be adjusted according to the detected force values 310 and positions of the sensors 140 with respect to their respective center plates 122.

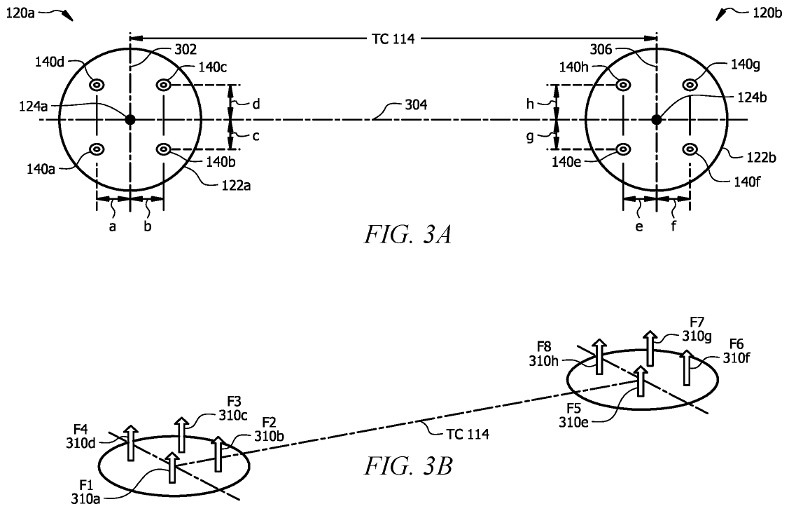

In certain embodiments, the COG_{V} 134 may be determined while the railcar 110 is in a dynamic condition, such as moving along a rail track. In certain embodiments, the COG_{V} 134 may be determined using a net force applied to the railcar 110. The net force and determining the COG_{V} 134 are described in FIG. 4.

FIG. 4 illustrates a side view of an embodiment of a railcar 110 with a net force 410 applied to the combined railcar body 116 and commodity's COG 130. This net force 410 may be applied to the railcar 110 through the couplers that connect the railcar 110 to the adjacent railcars. In the example of FIG. 4, the railcar 110 is in a dynamic condition, such as moving along a rail track. When the railcar 110 is moved from a stationary condition to a moving condition, the railcar 110 is subjected to acceleration.

For example, when a railcar 110 is within a train line connected to a locomotive and the locomotive starts to move the railcars 110, the railcar 110 experiences pulling forces from railcars on either end. Sometimes, these forces can be abrupt as the railcar couplers extend and absorb the force from the locomotive. The COG 130 of the commodity carried by the railcar 110 experiences this force. Thus, the railcar body 116 and commodity carried by the railcar 110 experiences acceleration at its COG 130. By measuring the acceleration in the longitudinal direction (i.e., along the length of the railcar 110) and force values 310a to 310h, the COG_{V} 134 may be determined.

The acceleration of the railcar 110 may be determined by an accelerometer or other inertial measurement devices. Knowing the acceleration, the net force 410 can be calculated by multiplying the acceleration (a) by the mass (m) of the railcar 110 according to equation (5) as below:

F=m×a Eq. (5)

where m corresponds to the mass of the railcar 110, a corresponds to the acceleration of the railcar 110, and F corresponds to a net force 410 experienced by the railcar 110. The net force 410 is experienced at the COG 130 of the commodity and creates a momentum that can be measured by the sensors 140.

Another way the net force 410 can be measured is by determining forces on the couplers of each end of the railcar 110. The force values on the couplers may be determined using a BMG sensor, a pressure sensor, or any other type of sensor that is configured to determine force values applied to the sensor.

For example, assume that the railcar 110 is connected to adjacent railcars on either end via couplers. The adjacent railcars may pull the railcar 110 by a force. For example, if a first force value on a first coupler at a first end of the railcar 110 is measured at 10,000 lbs. in the left direction, and a second force value on a second coupler at a second end of the railcar 110 is measured at 3000 lbs. in the right direction, the net force 410 applied to the railcar 110 is 7000 lbs. in the left direction.

In one embodiment, the COG_{V} 134 may be determined using the COG_{L} 132, the net force 410, and other variables, including the force values 310a to 310h (i.e., F1-F8), the location of each sensor 140a to 140h with respect to its respective center plate 122a or 122b, and the weight of the railcar 110. For example, the COG_{V} 134 may be determined according to an equation (6) as below:

$${COG}_{V} = [ \begin{matrix}- ( F 1 + F 4 ) \times a + ( F 2 + F 3 ) \times b + ( F 5 + F 8 ) \times \\ ( TC - e ) + ( F 6 + F 7 ) \times ( TC + f ) - W \times {COG}_{L}\end{matrix} ] / F \qquad Eq . ( 6 )$$

The variables F1-F8, a, b, e, f, TC, W, COG_{L} 132, and F (i.e., net force 410) are described above.

In an alternative embodiment, the COG_{V} 134 may be determined using the COG_{T} 136, the net force 410, and other variables including the force values 310a to 310h (i.e., F1-F8), the location of each sensor 140a to 140h with respect to its respective center plate 122a or 122b, and the weight of the railcar 110. For example, the COG_{V} 134 may be determined according to an equation (7) as below:

COG_{V}=[−(F1+F2)×c+(F3+F4)×d−(F5+F6)×g+(F7+F8)×h−W×COG_{T}]/F Eq. (7)

The variables F1-F8, a, b, e, f, TC, W, COG_{T} 136, and F (i.e., net force 410) are described above.

In certain embodiments, the COG_{V} 134 may be determined using the transverse (i.e., side-to-side) acceleration of the railcar 110 along the width of the railcar 110. For example, the weight of the railcar body 116 and commodity may be used to determine the transverse forces experienced at the COG 130 of the commodity.

Using the weight of the railcar body 116 and commodity and the measurements of the sensors 140a to 140h, the COG_{V} 134 may be determined according to either of the equations (6) or (6) described above. However, because the railcar 110 is relatively narrow, any lateral movement due to track slope and/or truck spring deflection may add significant error to the COG_{V} 134 calculation. The truck spring deflection may correspond to how far the spring used in the underframe of the railcar 110 moves in response to experiencing a force. The truck spring deflection may be calculated by multiplying the experienced force and a spring constant value. Thus, other measurements, such as the levelness of the railcar 110 body and truck spring deflection, may be used to account for the effects of track slope and truck spring deflection to increase the accuracy of the COG_{V} 134 calculation.

The height of the COG 130 (i.e., the COG_{V} 134) is much shorter compared to the longitudinal length of the railcar 110 (as can be seen in FIGS. 1A and 4). Thus, the effects of vertical movements at the sensors 140 due to vertical forces have a minimal effect on the accuracy of the COG_{V} 134 calculation.

For transverse measurements of the COG 130, the height of the COG 130 (i.e., the COG_{V} 134) may be close to the width of the railcar 110. Thus, the transverse measurements of the COG 130 may be more susceptible to noise due to side-to-side rocking.

When the measurements of the sensors 140 are taken while the railcar 110 is in motion, more data points and/or more processing of the measurements may be needed to reduce the noise in determining the COG_{V} 134. For example, outlier data point removal and/or statistical data analysis may be used to reduce the noise in determining the COG_{V} 134.

The calculations described in this disclosure are simplified for illustration purposes. However, the present disclosure contemplates accounting for several factors that may affect the accuracy of these calculations. For example, such factors may include a rolling resistance between the railcar 110 and the rail. The rolling resistance may correspond to a force resisting the motion of the railcar 110 when the railcar 110 body rolls on the rail. In another example, such factors may include a brake draft and an aerodynamic drag, both of which may reduce the force being applied to the COG 130 in the longitudinal direction, i.e., along the length of the railcar 110. In another example, such factors may include the movement of the commodity during an acceleration event. In another example, such factors may include the railcar 110 and commodity experiencing external forces such as wind, rail slope, and friction of the center plate components, among others.

In certain embodiments, measurements of the sensors 140 during transport (e.g., while the railcar 110 is in motion) may reduce or overcome some of the effects of inaccurate COG_{V} 134 determination. For example, frictions of the center plate pins 124 in the center plates 122 may affect the measurement of the weight of the railcar 110. When a center plate pin 124 is sticking vertically due to friction, the sensor 140 may not experience all of the weight of the railcar body 116 and commodity as some of the weight of the railcar body 116 and commodity may be taken and absorbed by the frictions of the center plate pins 124. However, when the railcar 110 is in motion, the vibrations from the movement may reduce the frictions of the center plate pins 124. In this manner, the noise from the frictions of the center plate pins 124 may be reduced if the measurements of the sensors 140 are carried out when the railcar 110 is in motion.

In some cases, vertical accelerations (and vertical movements of the railcar 110) due to dynamic forces experienced by the sensors 140 during transport (i.e., while the railcar 110 is in motion) may affect the weight of the railcar 110 due to inertial effects. For example, when the railcar 110 is moving over a bump, the railcar 110 may move up and down as it goes over the bump. During this event, the sensors 140 may detect a weight other than the actual weight of the railcar 110. For example, if the railcar 110 is bouncing upward, the sensors 140 may measure a weight more than the actual weight of the railcar 110. In another example, if the railcar 110 is bouncing downward, the sensors 140 may measure a weight less than the actual weight of the railcar 110.

With an additional input, such as from a vertical accelerometer or an inertial measuring device, corrections can be made to improve the accuracy of the calculations of the weight, COG_{L} 132, COG_{V} 134, and COG_{T} 136. In other words, by obtaining the vertical accelerometer data indicating that the railcar 110 is experiencing a vertical acceleration, a more accurate weight, COG_{L} 132, COG_{V} 134, and COG_{T} 136 may be obtained. For example, if the vertical accelerometer data indicates that the railcar 110 is experiencing a vertical acceleration, the weight, COG_{L} 132, COG_{V} 134, and COG_{T} 136 may not be calculated while the railcar 110 is experiencing a vertical acceleration. In another example, if the vertical accelerometer data indicates that the railcar 110 is experiencing a vertical acceleration, the weight, COG_{L} 132, COG_{V} 134, and COG_{T} 136 may be given a lower confidence level compared to situations when the railcar 110 does not experience a vertical acceleration. In another example, if the vertical accelerometer data indicates that the railcar 110 is experiencing a vertical acceleration, the weight, COG_{L} 132, COG_{V} 134, and COG_{T} 136 may be ignored.

In some cases, side bearings may place substantial forces on the body of the railcar 110. Typically, there are four side bearings, two on each end of the railcar 110. The side bearings limit the motion of the railcar 110 with respect to the trucks. The forces that the side bearings place on the railcar 110 can be measured and taken into account in the calculations of the COG_{L} 132, COG_{V} 134, and COG_{T} 136. The forces that the side bearings place on the railcar 110 may be measured by a pressure sensor or any other type of sensor that is configured to determine a force value.

One way to overcome or reduce some or all of the factors that affect the calculations of the weight 112, COG_{L} 132, COG_{V} 134, and COG_{T} 136 is to take multiple measurements from the sensors 140 over time. For example, multiple measurements from the sensors 140 may be taken at a frequency, such as every ten seconds, every minute, or any other suitable time interval. Any of the weight 112, COG_{L} 132, COG_{V} 134, and COG_{T} 136 may be measured using the measurements from the sensors 140 over time.

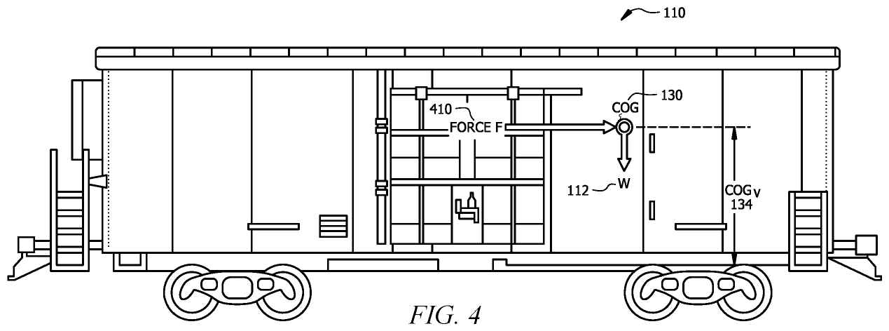

FIG. 5 illustrates an example plot 510 of COG_{V} 134 calculations over time. The values of the COG_{V} 134 may be analyzed to determine a more accurate COG_{V} 134 with a high level of confidence. For example, an average of the values of the COG_{V} 134 may be determined. In another example, outlier data points in the values of the COG_{V} 134 may be removed before determining the average of the values of the COG_{V} 134. The outlier data points may include values of the COG_{V} 134 that are measured when the railcar 110 is experiencing vertical accelerations.

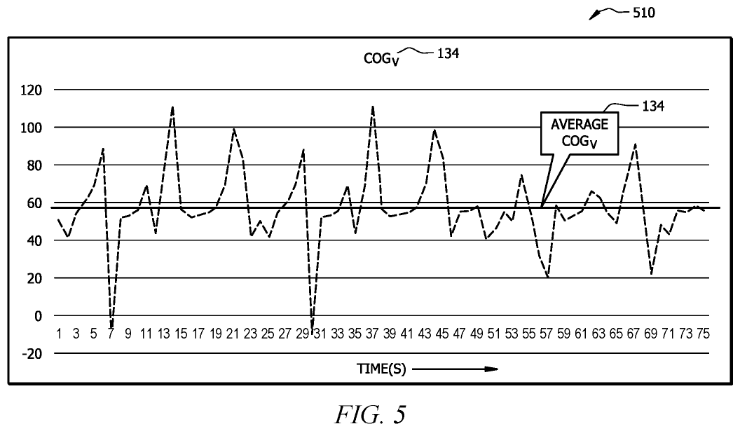

FIG. 6 illustrates an embodiment of system 600 configured to determine the COG 130 of a combined railcar body 116 and commodity carried by a railcar 110 and its weight applied to each truck. In one embodiment, the system 600 may include a plurality of sensors 140 communicatively coupled with a computing device 610 via a network 602. The system 600 may be configured as shown or in any other configuration.

Determining the weight 112 and COG 130 can save time and reduce (or eliminate) errors from manual calculations and inaccurate information about the commodity weight. This is especially advantageous when the railcar 110 transports commodities that have different loading locations or drop-off locations that change the COG 130. In addition, calculations of the weight 112 and the COG 130 can help avoid accidental overloading of commodities and railcar components, and indicate when any of the COG_{V} 134 or COG_{T} 136 may be approaching or exceeding acceptable threshold limits.

The present disclosure describes methods for obtaining the weight 112 and COG 130 without the need to move the railcar 110 to special locations (e.g., a weighing station) using special scales to weigh the railcar 110 and determine the COG 130. This allows for a more efficient operation for determining the weight 112 and COG 130 by eliminating railcar movements.

Integrating the sensors 140 into the railcar 110 allows calibrations of the sensors 140 to be contained within the system 600. Differences in materials and constructions of railcars 110 do not affect the accuracy of the weight 112 and COG 130 measurements in various types of railcars 110, meaning that the system 600 may not have to be calibrated to each individual railcar 110, as required by other existing systems, because the calibration is internal to the system 600. This can reduce the cost and time for implementing the system 600 and allows it to be installed for a wide variety of railcar components, regardless of the manufacturer of the railcar or railcar component. For example, the railcar trucks can be swapped with other manufacturer trucks without requiring recalibration or affecting the accuracy of the weight 112 and COG 130 measurements.

With the methods of determining the weight 112 and COG 130 described herein, no special considerations need to be made as to whether the railcar 110 is stationary or in motion, unlike the existing methods which require the railcar 110 to be stationary. In addition, existing systems provide inaccurate measurements due to temperature changes, especially when said systems are mounted on railcar trucks. The temperature changes of components of the railcar 110 may be due to braking-generated heat, the friction of railcar truck components, and the absorption of reflected heat from the ground. System 600 is configured to minimize these effects as described above.

The computing device 610 includes a processing circuitry 612. The processing circuitry 612 includes one or more processors 604 in signal communication with a memory 608. The memory 608 stores software instructions 606 that when executed by the one or more processor 604 cause the computing device 610 to perform one or more functions described herein. For example, when the software instructions 606 are executed, the computing device 610 determines the weight 112, COG 130, COG_{L} 132, COG_{V} 134, and COG_{T} 136 in response to receiving measurements from the sensors 140, e.g., the force values 310a to 310h over the network 602.

In some embodiments, computing device 610 comprises wireless communication circuitry for communication over a wireless network. The wireless network may comprise and/or interface with any type of communication, telecommunication, data, cellular, and/or radio network or other similar types of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards, including Internet-of-Things (IoT), vehicle to vehicle communication (V2V), etc.; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

One or more processors 604 may be implemented as one or more central processing unit (CPU) chips, logic units, cores (e.g., a multi-core processor), field-programmable gate array (FPGAs), application-specific integrated circuits (ASICs), or digital signal processors (DSPs). The one or more processors are configured to implement various instructions 606 to determine the weight, COG 130, COG_{L} 132, COG_{V} 134, and COG_{T} 136. The one or more processors 604 may be implemented in hardware and/or software.

Memory 608 comprises one or more disks, tape drives, or solid-state drives, and may be used as an over-flow data storage device, to store programs when such programs are selected for execution, and to store instructions and data that are read during program execution, such as instructions and logic rules. Memory 608 may be volatile or non-volatile and may comprise read-only memory (ROM), random access memory (RAM), ternary content-addressable memory (TCAM), dynamic RAM (DRAM), and/or static RAM (SRAM). Memory 608 may comprise cloud storage. Memory 608 is operable to store, for example, instructions 606, weight 112, weight on truck assembly 120a, weight truck assembly 120b, force values 310a-310h, distances 614, COG 130, COG_{L} 132, COG_{V} 134, COG_{T} 136, and/or any data/instructions. The distances 614 may include the variables a, b, c, d, e, f, g, h, and TC 114 described in FIG. 3A.

Network 602 may be any suitable type of wireless and/or wired network, including, but not limited to, all or a portion of the Internet, an Intranet, a private network, a public network, a peer-to-peer network, the public switched telephone network, a cellular network, a local area network (LAN), a metropolitan area network (MAN), a wide area network (WAN), and a satellite network. The network 602 may be configured to support any suitable type of communication protocol as would be appreciated by one of ordinary skill in the art.

The operational flow of the system 600 begins when the computing device 610 receives force values 310a to 310h from the sensors 140a to 140h via the network 602.

In this process, the computing device 610 may receive a first set of one or more force values 310 (e.g., force values 310a to 310d) from the first set of one or more sensors 140 (e.g., sensors 140a to 140d) disposed on the first center plate 122a. The force values 310a to 310d are described in FIGS. 3A and 3B.

The computing device 610 may receive a second set of one or more force values 310 (e.g., force values 310e to 310h) from the second set of one or more sensors 140 (e.g., sensors 140e to 140h) disposed on the second center plate 122b. The force values 310e to 310h are described in FIGS. 3A and 3B.

The computing device 610 determines the weight of the railcar 110 by combining the received force values 310a to 310h. For example, the computing device 610 may determine the weight of the railcar 110, using the equation (1) described above in FIGS. 3A and 3B. Railcar weight applied to each truck assembly 120 at the center plates 122 may also be calculated using the equation (2). The computing device 610 determines the COG 130 of the railcar body 116 and commodity of the railcar 110 based on the received force values 310a to 310h, the positions of the sensors 140 (e.g., distances 614), and the weight of the railcar 110. For example, the computing device 610 may determine the COG 130 by determining the COG_{L} 132 according to the equation (3); the COG_{T} 136 according to the equation (4); and the COG_{V} 134 according to either of the equations (6) or (7) described above.

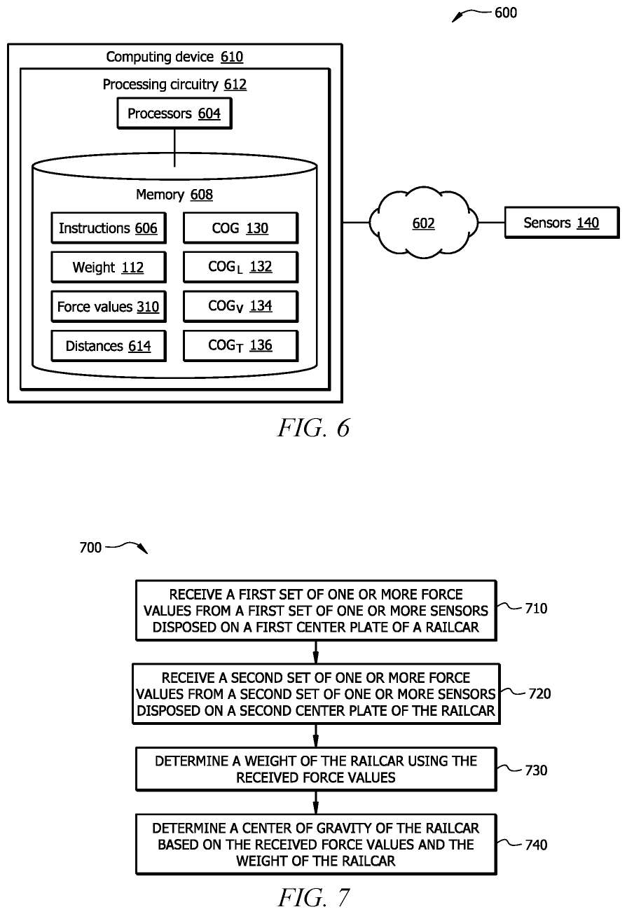

FIG. 7 illustrates an example method 700 for determining a COG 130 of a commodity of a railcar 110. Modifications, additions, or omissions may be made to method 700. Method 700 may include more, fewer, or other operations. The operations of the method 700 may be performed in parallel or in any suitable order. While at times discussed as the system 600 of FIG. 6 or components thereof performing operations, any suitable system or components of the system may perform one or more operations of the method 700. For example, one or more operations of method 700 may be implemented, at least in part, in the form of software instructions 606 of FIG. 6, stored on non-transitory, tangible, machine-readable media (e.g., memory 608 of FIG. 6) that when run by one or more processors (e.g., processor 604 of FIG. 6) may cause the one or more processors to perform operations 710-740.

At 710, the computing device 610 receives a first set of one or more force values 310 (e.g., force values 310a to 310d) from the first set of one or more sensors 140 (e.g., sensors 140a to 140d) disposed on the first center plate 122a of a railcar 110.

At 720, the computing device 610 receives a second set of one or more force values 310 (e.g., force values 310e to 310h) from the second set of one or more sensors 140 (e.g., sensors 140e to 140h) disposed on the second center plate 122b of the railcar 110.

At 730, the computing device 610 determines a weight of the railcar body 116 and commodity using the received force values 310, similar to that described above.

At 740, the computing device 610 determines a COG 130 of a railcar body 116 and commodity of the railcar 110 based on the received force values 310 and the weight of the railcar body 116 and commodity. For example, the computing device 610 may determine the COG 130 by determining the COG_{L} 132 according to the equation (3); the COG_{T} 136 according to the equation (4); and the COG_{V} 134 according to either of the equations (6) or (7) described above.

Although particular embodiments and their advantages have been described in detail, it should be understood that various changes, substitutions, and alternations could be made herein without departing from the spirit and scope of the embodiments. Particular embodiments of the present disclosure described herein may be used or mounted for a railroad car, a semi-trailer, a truck, or any other transportations. The illustrations referred to in the above description were meant not to limit the present disclosure but rather to serve as examples of embodiments thereof and so the present invention should only be measured in terms of the claims, which follow.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. A system for determining railcar attributes, comprising:
a plurality of sensors comprising:
a first set of one or more sensors disposed on a first center plate of a railcar;
a second set of one or more sensors disposed on a second center plate of the railcar, wherein each sensor from the plurality of sensors is configured to determine a change in force imposed on the sensor based on a change in microstrain on the sensor;
a computing device communicatively coupled with the plurality of sensors, and comprises a processor configured to:
receive a first set of one or more force values from the first set of one or more sensors;
receive a second set of one or more force values from the second set of one or more sensors;
determine a weight of a railcar body and a commodity loaded in the railcar by combining the first set of one or more force values and the second set of one or more force values; and
determine a center of gravity (COG) of the combined railcar body and the commodity based at least on the first set of one or more force values, the second set of one or more force values, and the weight of the combined railcar body and the commodity.

2. The system of claim 1, wherein the processor is further configured to determine a longitudinal COG (COG_{L}), wherein the COG_{L} corresponds to a center of mass of the railcar body and the commodity with respect to a longitudinal axis of the railcar.

3. The system of claim 2, wherein the COG_{L} is determined according to an equation:
$${COG}_{L} = [ \begin{matrix}- ( F 1 + F 4 ) \times a + ( F 2 + F 3 ) \times b + ( F 5 + F 8 ) \times \\ ( TC - e ) + ( F 6 + F 7 ) \times ( TC + f )\end{matrix} ] / W$$
wherein:
F1-F4 correspond to the first set of one or more force values, F1 is determined by a first sensor from the first set of one or more sensors, F2 is determined by a second sensor from the first set of one or more sensors, F3 is determined by a third sensor from the first set of one or more sensors, and F4 is determined by a fourth sensor from the first set of one or more sensors;
F5-F8 correspond to the second set of one or more force values, F5 is determined by a fifth sensor from the second set of one or more sensors, F6 is determined by a sixth sensor from the second set of one or more sensors, F7 is determined by a seventh sensor from the second set of one or more sensors, and F8 is determined by an eighth sensor from the second set of one or more sensors;
W corresponds to the weight of the railcar body and the commodity;
TC corresponds to a distance between a center of the first center plate and a center of the second center plate;
a corresponds to a distance between each of the first sensor and the fourth sensor to a vertical centerline of the first center plate;
b corresponds to a distance between each of the second sensor and the third sensor to the vertical centerline of the first center plate;
e corresponds to a distance between each of the fifth sensor and the eighth sensor to a vertical centerline of the second center plate;
f corresponds to a distance between each of the sixth sensor and the seventh sensor to the vertical centerline of the second center plate;
the first sensor and the fourth sensor are disposed adjacent to a first end of the railcar;
the second sensor and the third sensor are disposed adjacent to a middle of the railcar;
the fifth sensor and the eighth sensor are disposed adjacent to the middle of the railcar; and
the sixth and the seventh sensor are disposed adjacent to a second end of the railcar.

4. The system of claim 1, wherein the processor is further configured to determine a transverse COG (COG_{T}), wherein the COG_{T} corresponds to a distance between a center of mass of the railcar body and the commodity and a center of a width of the railcar.

5. The system of claim 4, wherein the COG_{T} is determined according to an equation:
COG_{T}=[−(F1+F2)×c+(F3+F4)×d−(F5+F6)×g+(F7+F8)×h]/W
wherein:
F1-F4 correspond to the first set of one or more force values, F1 is determined by a first sensor from the first set of one or more sensors, F2 is determined by a second sensor from the first set of one or more sensors, F3 is determined by a third sensor from the first set of one or more sensors, and F4 is determined by a fourth sensor from the first set of one or more sensors;
F5-F8 correspond to the second set of one or more force values, F5 is determined by a fifth sensor from the second set of one or more sensors, F6 is determined by a sixth sensor from the second set of one or more sensors, F7 is determined by a seventh sensor from the second set of one or more sensors, and F8 is determined by an eighth sensor from the second set of one or more sensors;
W corresponds to the weight of the railcar body and the commodity;
TC corresponds to a distance between a center of the first center plate and a center of the second center plate;
c corresponds to a distance between each of the first sensor and the second sensor to a horizontal centerline of the first side of the first center plate;
d corresponds to a distance between each of the third sensor and the fourth sensor to the horizontal centerline of the second side of the first center plate;
g corresponds to a distance between each of the fifth sensor and the sixth sensor to a horizontal centerline of the first side of the second center plate;
h corresponds to a distance between each of the seventh sensor and the eighth sensor to the horizontal centerline of the second side of the second center plate;
the first sensor and the fourth sensor are disposed adjacent to a first end of the railcar;
the second sensor and the third sensor are disposed adjacent to a middle of the railcar;
the fifth sensor and the eighth sensor are disposed adjacent to the middle of the railcar; and
the sixth and the seventh sensor are disposed adjacent to a second end of the railcar.

6. The system of claim 1, wherein the processor is further configured to determine a vertical COG (COG_{V}), wherein the COG_{V} corresponds to a height of a center of mass of the railcar body and the commodity from a center plate of the railcar.

7. The system of claim 6, wherein the COG_{V} is determined according to an equation:
$${COG}_{V} = [ \begin{matrix}- ( F 1 + F 4 ) \times a + ( F 2 + F 3 ) * b + ( F 5 + F 8 ) \times \\ ( TC - e ) + ( F 6 + F 7 ) \times ( TC + f ) - W \times {COG}_{L}\end{matrix} ] / F$$
wherein the COG_{V} is determined while the railcar is in motion;
wherein:
F corresponds to a net force determined according to an equation F=m×a;
m corresponds to a mass of the railcar body and the commodity; and
a corresponds to an acceleration of the railcar.

8. The system of claim 6, wherein the COG_{V} is determined according to an equation:
COG_{V}=[−(F1+F2)*c+(F3+F4)*d−(F5+F6)*g+(F7+F8)*h−W*COG_{T}]/F
wherein the COG_{V} is determined while the railcar is in motion,
wherein:
F corresponds to a net force determined according to an equation F=m×a;
m corresponds to a mass of the railcar body and the commodity; and
a corresponds to an acceleration of the railcar.

9. The system of claim 1, wherein each of the plurality of sensors comprises:
a bulk metallic glass plug disposed on a center plate of the railcar; and
a micro strain sensor coupled to the bulk metallic glass plug, wherein the micro strain sensor is operable to determine a change in micro strain on the bulk metallic glass plug.

10. The system of claim 1, wherein the computing device is communicatively coupled to the plurality of sensors via one or more wires.

11. The system of claim 1, wherein the computing device is communicatively coupled wirelessly to the plurality of sensors.

12. A method for determining railcar attributes, comprising:
receiving a first set of one or more force values from a first set of one or more sensors, wherein the first set of one or more sensors is disposed on a first center plate of a railcar;
receiving a second set of one or more force values from a second set of one or more sensors, wherein the second set of one or more sensors is disposed on a second center plate of the railcar, and wherein each sensor from the first set of one or more sensors and the second set of one or more sensors is configured to determine a change in force imposed on the sensor based on a change in microstrain on the sensor;
determining a weight of a railcar body and a commodity loaded in the railcar by combining the first set of one or more force values and the second set of one or more force values; and
determining a center of gravity (COG) of the combined railcar body and the commodity based at least on the first set of one or more force values, the second set of one or more force values, and the weight of the combined railcar body and the commodity.

13. The method of claim 12, wherein determining the COG comprises determining a longitudinal COG (COG_{L}), wherein the COG_{L} corresponds to a center of mass of the railcar body and the commodity with respect to a longitudinal axis of the railcar.

14. The method of claim 13, wherein the COG_{L} is determined according to an equation:
COG_{L}=[−(F1+F4)×a+(F2+F3)×b+(F5+F8)×(TC−e)+(F6+F7)×(TC+f)]/W
wherein:
F1-F4 correspond to the first set of one or more force values, F1 is determined by a first sensor from the first set of one or more sensors, F2 is determined by a second sensor from the first set of one or more sensors, F3 is determined by a third sensor from the first set of one or more sensors, and F4 is determined by a fourth sensor from the first set of one or more sensors;
F5-F8 correspond to the second set of one or more force values, F5 is determined by a fifth sensor from the second set of one or more sensors, F6 is determined by a sixth sensor from the second set of one or more sensors, F7 is determined by a seventh sensor from the second set of one or more sensors, and F8 is determined by an eighth sensor from the second set of one or more sensors;
W corresponds to the weight of the railcar body and the commodity;
TC corresponds to a distance between a center of the first center plate and a center of the second center plate;
a corresponds to a distance between each of the first sensor and the fourth sensor to a vertical centerline of the first center plate;
b corresponds to a distance between each of the second sensor and the third sensor to the vertical centerline of the first center plate;
e corresponds to a distance between each of the fifth sensor and the eighth sensor to a vertical centerline of the second center plate;
f corresponds to a distance between each of the sixth sensor and the seventh sensor to the vertical centerline of the second center plate;
the first sensor and the fourth sensor are disposed adjacent to a first end of the railcar;
the second sensor and the third sensor are disposed adjacent to a middle of the railcar;
the fifth sensor and the eighth sensor are disposed adjacent to the middle of the railcar; and
the sixth and the seventh sensor are disposed adjacent to a second end of the railcar.

15. The method of claim 12, wherein determining the COG comprises determining a transverse COG (COG_{T}), wherein the COG_{T} corresponds to a distance between a center of mass of the railcar body and the commodity and a center of a width of the railcar.

16. The method of claim 15, wherein the COG_{T} is determined according to an equation:
COG_{T}=[−(F1+F2)×c+(F3+F4)×d−(F5+F6)×g+(F7+F8)×h]/W
wherein:
F1-F4 correspond to the first set of one or more force values, F1 is determined by a first sensor from the first set of one or more sensors, F2 is determined by a second sensor from the first set of one or more sensors, F3 is determined by a third sensor from the first set of one or more sensors, and F4 is determined by a fourth sensor from the first set of one or more sensors;
F5-F8 correspond to the second set of one or more force values, F5 is determined by a fifth sensor from the second set of one or more sensors, F6 is determined by a sixth sensor from the second set of one or more sensors, F7 is determined by a seventh sensor from the second set of one or more sensors, and F8 is determined by an eighth sensor from the second set of one or more sensors;
W corresponds to the weight of the railcar body and the commodity;
TC corresponds to a distance between a center of the first center plate and a center of the second center plate;
c corresponds to a distance between each of the first sensor and the second sensor to a horizontal centerline of the first side of the first center plate;
d corresponds to a distance between each of the third sensor and the fourth sensor to the horizontal centerline of the second side of the first center plate;
g corresponds to a distance between each of the fifth sensor and the sixth sensor to a horizontal centerline of the first side of the second center plate;
h corresponds to a distance between each of the seventh sensor and the eighth sensor to the horizontal centerline of the second side of the second center plate;
the first sensor and the fourth sensor are disposed adjacent to a first end of the railcar;
the second sensor and the third sensor are disposed adjacent to a middle of the railcar;
the fifth sensor and the eighth sensor are disposed adjacent to the middle of the railcar; and
the sixth and the seventh sensor are disposed adjacent to a second end of the railcar.

17. The method of claim 12, wherein determining the COG comprises determining a vertical COG (COG_{V}), wherein the COG_{V} corresponds to a height of a center of mass of the railcar body and the commodity from a center plate of the railcar.

18. The method of claim 17, wherein the COG_{V} is determined according to an equation:
$${COG}_{L} = [ \begin{matrix}- ( F 1 + F 4 ) \times a + ( F 2 + F 3 ) \times b + ( F 5 + F 8 ) \times \\ ( TC - e ) + ( F 6 + F 7 ) \times ( TC + f ) - W \times {COG}_{L}\end{matrix} ] / F$$
wherein the COG_{V} is determined while the railcar is in motion;
wherein:
F corresponds to a net force determined according to an equation F=m×a;
m corresponds to a mass of the railcar; and
a corresponds to an acceleration of the railcar.

19. The method of claim 17, wherein the COG_{V} is determined according to an equation:
COG_{V}=[−(F1+F2)×c+(F3+F4)×d−(F5+F6)×g+(F7+F8)×h−W×COG_{T}]/F
wherein the COG_{V} is determined while the railcar is in motion,
wherein:
F corresponds to a net force determined according to an equation F=m×a;
m corresponds to a mass of the railcar; and
a corresponds to an acceleration of the railcar.

20. The method of claim 12, wherein each sensor from the first set of one or more sensors and the second set of one or more sensors comprises:
a bulk metallic glass plug disposed on a center plate of the railcar; and
a micro strain sensor coupled to the bulk metallic glass plug, wherein the micro strain sensor is operable to determine a change in micro strain on the bulk metallic glass plug.

21. The method of claim 12, further comprising:
determining a first railcar body and commodity weight on a first truck assembly according to an equation:
W₁=F1+F2+F3+F4
wherein F1-F4 correspond to the first set of one or more force values.

22. The method of claim 12, further comprising:
determining a second railcar body and commodity weight on a second truck assembly according to an equation:
W₂=F5+F6+F7+F8
wherein F5-F8 correspond to the second set of one or more force values.

23. The method of claim 12, further comprising:
determining a second weight of the commodity by subtracting a third weight of an empty railcar body from the weight of the railcar body loaded with the commodity.

24. The method of claim 12, further comprising:
determining a second COG of the commodity by subtracting a third COG of an empty railcar body from the COG of the railcar body loaded with the commodity.
